(19) United States
(12) Patent Application Publication
(10) Pub. No.: US 2011/0161051 A1
(43) Pub. Date: Jun. 30, 2011

(54) METHOD AND DEVICE FOR REMOTELY MONITORING MANUAL VALVES OF FLUID SYSTEMS IN THE NUCLEAR ISLAND OF A NUCLEAR POWER STATION

(75) Inventors: Jean-Jacques Vander Linden, Morestel (FR); Daniel Garzenne, Lyon (FR); Guy Le Rat, Ste Foy Les Lyon (FR)

(73) Assignee: AREVA NP

(21) Appl. No.: 12/997,422

(22) PCT Filed: Jun. 3, 2009
(86) PCT No.: PCT/FR09/51044

§ 371 Date: Mar. 21, 2011

(30) Foreign Application Priority Data
Jun. 10, 2008 (FR) 0853837

(51) Int. Cl. G06F 15/00

(52) U.S. Cl. 702/188

(57) ABSTRACT

A method for remotely monitoring manual valves of fluid systems in the nuclear island of a power station, in which method the manual valves are provided with detectors for detecting their open or closed position and first communication device for wireless communication of the signals relating to the position of each valve, second communication device for communication of the signals are arranged at the locations of the valves, there are arranged local cable networks which allow the signals received to pass through thick walls, and there are arranged, at a monitoring location, processor for receiving and processing the signals after they have passed through the walls. A device used for all fluid systems which includes manual valves whose positions must be monitored remotely.

The present invention relates to a method and a device for remotely monitoring manual valves of fluid systems in the nuclear island of a power station during its operation or periods of shutdown.

### BACKGROUND

In conventional manner, the nuclear island forms an assembly which surrounds the nuclear steam supply system and the installations relating to the fuel, and the equipment required for the operation and the safety of this assembly.

The nuclear steam supply system comprises, inside a reactor building, a vessel which contains the core of the reactor and which is filled with pressurised water, and a coolant system which is constituted by a plurality of loops which are in communication with the vessel. Each of the loops of the coolant system comprises a vapour generator in which the pressurised water of the coolant system is cooled, with the feedwater of the secondary system being heated and evaporated.

The vapour generators of each of the loops are connected to the vessel by means of pressurised water inlet and outlet pipes referred to as primary conduits. These conduits are connected to the channel head of the vapour generator, located at the lower portion thereof, by means of tubes which are fixedly joined to the channel head.

The equipment which is necessary for the operation and the safety of each island of the nuclear reactor comprises a plurality of fluid systems, such as, for example:
the normal feedwater system of the vapour generators,
the emergency feedwater system of the vapour generators,
the safety injection system,
the shutdown cooling system of the reactor,
the volumetric and chemical control system,
the filling system of the reactor cavity,
the intermediate cooling system, and
the cooling system of the exchangers.

The equipment also comprises:
the boric acid supply system which is intended to allow the reactivity of the core to be adjusted by adding neutron-absorbing boric acid in addition to adjusting the position of the clusters for adjusting the reactivity of the core, these clusters also being neutron-absorbing.

These hydraulic systems comprise, for transferring fluids between the various items of equipment, pipes which are provided with manual valves which can be moved between an open position and a closed position.

The manual valves are arranged in different rooms in buildings and the pipes extend through thick walls in order to transfer the fluids between the different components.

During the operation of the reactor or during its shutdown, the valves of the various systems are open or closed manually by operators in accordance with requirements.

The verification of the opening or closure of the valves of the same line or system is also carried out visually by operators.

In order to facilitate this visual verification of the position of the valves, each valve is provided with a rod which is fixedly joined to the body of the valve and a sliding member which translates along the rod during the rotation of a control wheel of the valve. In this manner, when the valve is in a closed position, the sliding member occupies a first position on the rod and, when this valve is in an open position, the sliding member occupies a second position on the rod which allows an operator to rapidly visualise the position of each valve.

However, owing to the significant number of valves in the different systems, it may be the case that an operator does not open or close a valve, with the result that the corresponding line is not in a configuration which corresponds to the function requested.

By way of example, in the case of the boric acid supply system, if the system does not perform its function by adding neutron-absorbing boric acid in addition to adjusting the position of the clusters for adjusting the reactivity of the core, the reestablishment of the borification function must be carried out within the hour, otherwise the hot shutdown of the reactor must be programmed within six hours.

Up to the present time, in order to limit this type of problem, the owners of nuclear power stations have placed the emphasis on the training of operators and the improvement of procedures, but the risks remain.

### SUMMARY OF THE INVENTION

An object of the invention is to provide a method and a device for remotely monitoring the placement of the system or the fluid line in an operating state, that is to say, monitoring the open or closed state of the manual valves, which is intended to allow the system or the line to carry out its function.

The invention provides a method for remotely monitoring manual valves of fluid systems in the nuclear island of a power station during its operation or periods of shutdown, the valves being able to be moved manually between an open or closed position, characterised in that:
the manual valves are provided with means for detecting their open or closed position and first means for wireless communication of the signals relating to the open or closed position of each valve,
there are arranged, at the location surrounding these valves, second means for communicating in particular signals transmitted by the first wireless communication means,
there are arranged, outside the location, local cable networks which allow the signals received by the second communication means to pass through thick walls which are impermeable with respect to the signals transmitted in a wireless manner, and
there are arranged, at a monitoring location, outside these locations, means for receiving and processing the signals after they have passed through the walls.

According to other features of the invention:
based on the transmission, activation and interrogation means which are associated with the receiving and processing means, the first communication means of each valve are actuated and the detection means are interrogated and transmit to the first communication means the open or closed position of each valve and, via the first communication means, the signals relating to the open or closed position of each valve are transmitted,
the receiving and processing means are connected directly to the cable networks, and
the receiving and processing means are connected to the cable networks by wireless means for transmitting and receiving the signals.

The invention also provides a device for remotely monitoring manual valves of fluid systems in the nuclear island of a power station during its operation or periods of shutdown, the valves being able to be moved manually between an open or closed position, characterised in that it comprises:
means for detecting the open or closed position of the valves and first means for wireless communication of the signals relating to the open or closed position of each valve,
second means for communicating in particular the signals transmitted by the first wireless communication means, the second communication means being at the location corresponding to the valves,
local cable networks which allow the signals received by the second communication means to pass through thick walls which are impermeable with respect to the signals transmitted in a wireless manner, and
means for receiving and processing the signals after they have passed through the walls.

According to other features of the invention, the device comprises, associated with the receiving and processing means, transmission, activation and interrogation means for actuating the first communication means of each valve via the second communication means and interrogating the means for detecting the open or closed position of each valve,
the means for detecting the open or closed position are mounted on each valve to be monitored,
the first means for wireless communication of the signals relating to the open or closed position are mounted on each valve to be monitored,
the detection means and the first wireless communication means form an independent assembly which is capable of being mounted on each valve to be monitored,
the first and second wireless communication means are of the radio wave or sound wave type,
the first and second wireless communication means are of the visible or invisible light wave type,
the first and second wireless communication means are of the infrared wave type, and
the detection means and the first wireless communication means are of the video camera type.

### BRIEF DESCRIPTION OF THE DRAWINGS

Other features and advantages of the invention will be appreciated from a reading of the following description, given by way of example and with reference to the appended drawings, in which:

FIG. 1 is a diagram of a system for adding boric acid into the coolant system of a nuclear reactor,

FIG. 2 is a schematic cross-section of a manual valve of such a system, in accordance with the prior art,

FIG. 3 is a schematic perspective view of a manual valve which is provided with means for detecting its position and wireless communication means for a remote monitoring device, according to the invention, and

FIG. 4 is a schematic view of a device for remotely monitoring the manual valves, in accordance with the invention.

### DETAILED DESCRIPTION

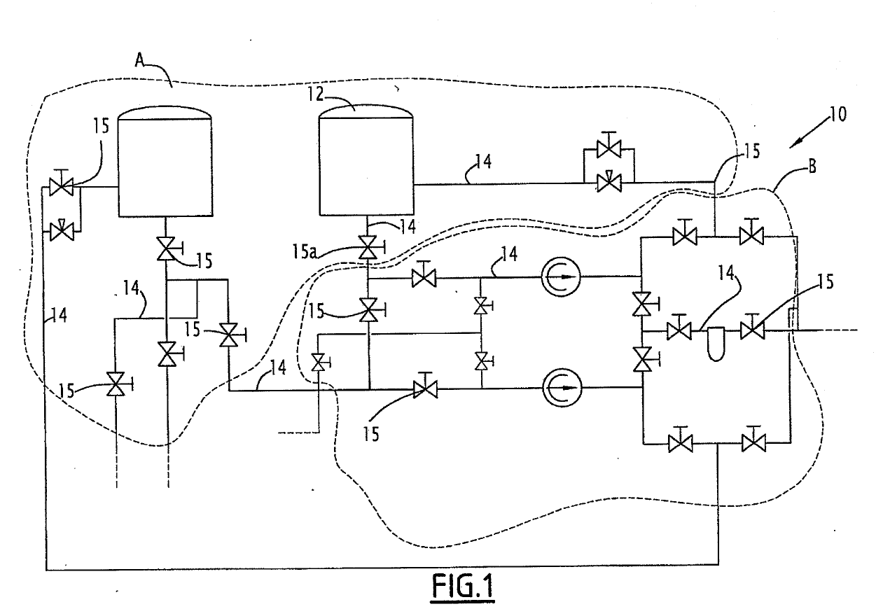

FIG. 1 illustrates, by way of example, a system 10 for adding neutron-absorbing boric acid into a coolant system of a nuclear reactor.

The system 10, which is arranged in a location, conventionally comprises a reservoir 12 of boric acid, this boric acid is intended to be mixed with water in accordance with a predetermined measure, before being introduced into the coolant system of the reactor.

This system 10 comprises a plurality of branches 14 which are each provided with one or more manual valves 15 which are open or closed by operators in accordance with requirements, that is to say, in accordance with the operation of the reactor.

If one of these valves, such as, for example, the valve 15a, has not been opened, the boric acid is not mixed with water and only water is introduced into the coolant system, which may have serious consequences and bring about a hot shutdown of the reactor.

As illustrated in FIG. 1, a first portion of the branches 14 and the valves 15 of the system 10 is arranged in a first room A and a second portion of the branches and the valves 15 of the system 10 is arranged in a second room B, the rooms A and B being separated by thick walls, in particular of reinforced concrete.

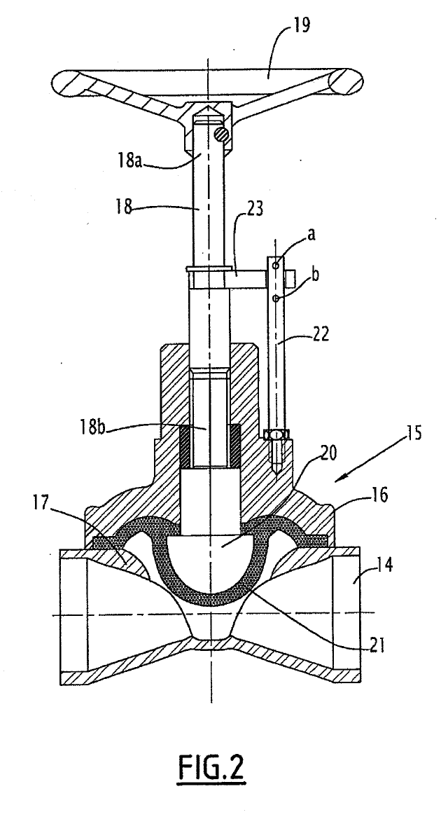

With reference to FIG. 2, a valve 15 will now be described, the other valves being identical.

The valve 15 comprises a body 16 which is intended to be mounted on a branch 14 of the system 10 and in which a valve seat 17 is provided.

The valve 15 also comprises a rod 18 which can be rotatably moved in the body 16 and which carries, at a first end 18a, a handwheel 19 and, at a second threaded end 18b, a valve 20 which carries a membrane 21, for example, of rubber. During the rotation of the handwheel 19, the rod 18 is caused to rotate and translate in order to move the valve 20 between a first position spaced from the valve seat 17 which corresponds to the opening position of the valve 15 for the passage of fluid into the corresponding pipe and a second position pressed against the valve seat 17 which corresponds to the closed position of the valve 15 in order to prevent the circulation of the fluid in the pipe.

The valve 15 also comprises a fixed rod 22 which is fixedly joined to the body 16 and which extends substantially parallel with the rod 18 and a sliding member 23 which is fixedly joined to the rod 18 and which extends substantially perpendicularly relative to the rod 18 and the fixed rod 22. The fixed rod 22 extends through the sliding member 23 so that, during the translational movement of the rod 18, the sliding member 23 moves on the fixed rod 22 between a first position (a) which corresponds to the open position of the valve 15 and a second position (b) which corresponds to the closed position of this valve 15.

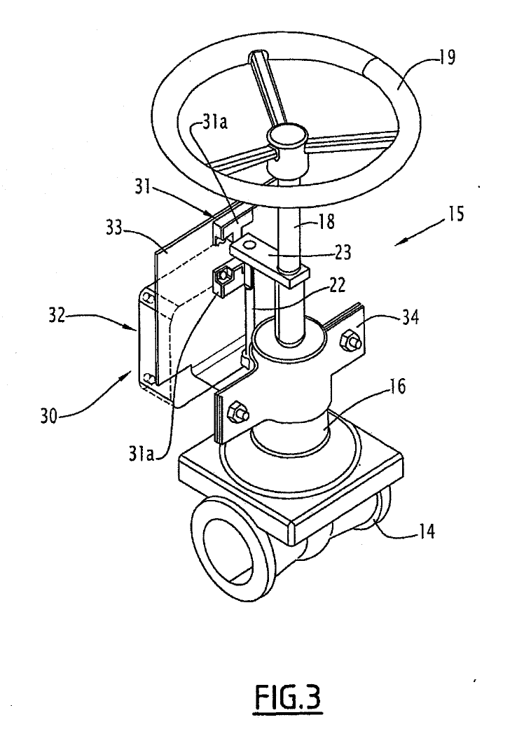

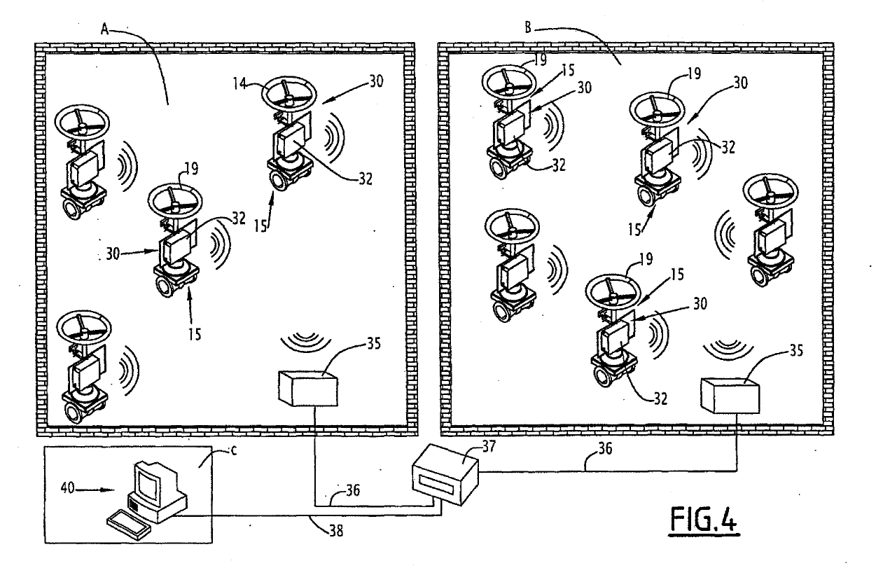

In order to remotely know, in particular in a monitoring location C (FIG. 4) which is independent from the rooms A and B, the open or closed position of the manual valves 15 of the system 10, each valve 15 is provided with an assembly 30 (FIG. 3) which comprises means 31 for detecting the open or closed position of the corresponding valve 15 and first means 32 for wireless communication of the signals relating to the open or closed position of the valve 15.

Preferably, and as illustrated in FIG. 3, the assembly 30 constitutes an independent assembly which is capable of being mounted on the body 16 of the valve 15. To this end, the assembly 30 comprises a support 33 which is provided with means for being fixed to the body 16 of the valve 15, such as, for example, a collar 34 or any other appropriate means.

The means 31 for detecting the open or closed position of the valve 15 comprise two switches of known type 31a and 31b, respectively, which are arranged close to the sliding member 23, of which one switch 31a detects the position (a) of the sliding member 23, that is to say, the open position of the valve 15, and the other switch 31b detects the position (b) of the sliding member 23, that is to say, the closed position of the valve 15.

In accordance with a first variant, only the detection means 31 are mounted on the support 33, close to the sliding member 23, whilst the first means 32 for wireless communication are separated from this support 33 and connected to the means 31, for example, by means of electrical connection wires.

In the example illustrated in the Figures, the first means 32 for wireless communication of signals relating to the open or closed position of the corresponding valve 15 are constituted by a transmitter of the radio wave type. These means 32 may also be of other types such as, for example:
the sound wave type,
visible or invisible light wave type, and
infrared wave type.

These means 31 and 32 may also be constituted by video cameras which allow the position of the valves 15 to be displayed in the monitoring location C.

In order to be able to transmit to the monitoring location C the signals transmitted by the first communication means 32 of each valve 15, second means 35 for communicating these signals are arranged in each room A and B, as illustrated in FIG. 4. These second means 35 are formed, for each room A and B, by a transmitter/receiver for the signals transmitted in a wireless manner.

Each second communication means 35 is connected, by means of a local cable network 36, to means 40 for receiving and processing the signals, arranged in the monitoring location C.

The signals, such as, for example, the radio waves can not pass through the thick walls which delimit each room A and B.

In the embodiment illustrated in FIG. 4, each second communication means 35 is connected, by means of a local cable network 36 which extends through the thick wall of each room, to means 37 of the communication system router type which are in turn connected to the means 40 for receiving and processing signals by means of a local cable network 38.

According to another embodiment, the second communication means 35 of each room may be connected by means of a local cable network to a transmitter which is located outside the room. In this instance, the means 40 for receiving and processing the signals arranged in the monitoring location C are connected by means of a local cable network to a receiver which allows the signals transmitted via each transmitter connected to the receivers of each room to be received.

The position of each manual valve 15 of the system 10 in each of the different rooms is therefore known instantaneously and therefore remotely on a display screen which is located in the monitoring location.

This display is, for example, in the form of a synoptic diagram, as shown in FIG. 1, which illustrates, using colours or any other means, the open or closed position of each valve.

According to another embodiment, the first communication means 32 of each valve 15 are supplied with energy by a battery which is integrated in the first means 32, and second communication means 35.

In order not to rapidly discharge the batteries of the communication means 32 and 35, these means 32 and 35 are deactivated.

When an operator wishes to know the position of the valves 15 of the system 10, he activates in the monitoring location C the first and second communication means 32 and 35.

To this end, the monitoring device comprises, associated with the receiving and processing means, transmission, activation and interrogation means which are not illustrated for actuating the communication means 32 and 35 of each valve 15, and interrogating the means 31 for detecting the open or closed position of each valve.

In this manner, when an operator wishes to know the position of the valves 15 of the system 10 at any given time, he activates the first communication means 32 of each valve 15 via the second communication means 35 and the transmission, activation and interrogation means which are arranged in the monitoring location C.

The detection means 31 are therefore interrogated and they transmit the open or closed position of each valve 15 to the first communication means 32. The signals relating to the position of each valve 15 are transmitted to the means 40 for receiving and processing the signals via the communication means 32 and 35.

The device is therefore used in a localised manner and in accordance with the verification requirements of the lines of the system, avoiding an excessive level of electricity consumption since the device returns to the monitoring position between each interrogation.

This operating mode further has the advantage of being much more economical than supplying electrical power to each valve using electrical cables.

The device according to the invention allows an operating mode in both directions, that is to say, on the one hand, in accordance with a mode for transmission of data transmitted by the detection means 31 to means 40 for receiving and processing the signals, and, on the other hand, in accordance with an activation and interrogation mode of the detection means 31, from the means associated with the means 40 for receiving and interrogating the signals.

In this manner, the position of each valve is known, which in the event of an incorrect position of one or more valves, allows one or more operators to be able to intervene to correct the malfunction so that the system or the line is under conditions which correspond to the functions requested.

The device according to the invention may, of course, be used for all fluid systems which comprise manual valves whose positions must be monitored remotely.

What is claimed is:

1-13. (canceled)

14. A method for remotely monitoring manual valves of fluid systems in the nuclear island of a power station during its operation or periods of shutdown, the manual valves being able to be moved manually between an open and a closed position, the method comprising the following steps:
providing the manual valves with a detector for detecting the open or closed position and a first communication device for wireless communication of signals relating to the open or closed position of each of the manual valves;
arranging a second communication device in a first location surrounding the manual valves, the second communication device for communicating the signals transmitted by the first communication device;
arranging local cable, at least in part, in a second location outside of the first location, the local cable allowing the signals received by the second communication device to pass through thick walls impermeable with respect to the signals transmitted in a wireless manner; and
arranging a processor at a monitoring location outside the first and second locations, the processor for receiving and processing the signals after the signals have passed through the walls.

15. The method according to claim 14 wherein the processor actuates the first communication device of each of the manual valves, interrogates the detector and transmits to the first communication device the open or closed position of each of the manual valves, and via the first communication device the signals relating to the open or closed position of each of the manual valves are transmitted.

16. The method according to claim 14 wherein the processor connects directly to the local cable.

17. The method according to claim 14 wherein the processor connects to the local cable by a wireless device.

18. A device for remotely monitoring manual valves of fluid systems in the nuclear island of a power station during its operation or periods of shutdown, the manual valves being able to be moved manually between an open or a closed position, the device comprising:
a detector for detecting the open or the closed position of the manual valves and a first communication device for wireless communication of signals relating to the open or the closed position of each of the manual valves;
a second communication device for communicating the signals transmitted by the first communication device, the second communication device being in a location corresponding to the manual valves;
local cable allowing the signals received by the second communication device to pass through thick walls impermeable with respect to the signals transmitted in a wireless manner; and
a processor for receiving and processing the signals after passing through the walls.

19. The monitoring device according to claim 18 wherein the processor includes transmission, activation and interrogation devices for actuating the first communication device of each of the manual valves via the second communication device and interrogating the detector for detecting the open or the closed position of each of the manual valves.

20. The monitoring device according to claim 18 wherein the detector is mounted on each of the manual valves to be monitored.

21. The monitoring device according to claim 18 wherein the first communication device is mounted on each of the manual valves to be monitored.

22. The monitoring device according to claim 18 wherein the detector and the first communication device form an independent assembly capable of being mounted on each of the manual valves to be monitored.

23. The monitoring device according to claim 18 wherein the first communication device and the second communication device communicate via radio waves or sound waves.

24. The monitoring device according 18 wherein the first communication device and the second communication device communicate via visible or invisible light waves.

25. The monitoring device according to claim 18 wherein the first communication device and the second communication device communicate via infrared waves.

26. The monitoring device according to claim 18 wherein the detector and the first communication device utilize video cameras.
